(19) United States
(12) Patent Application Publication
(10) Pub. No.: US 2023/0191326 A1
(43) Pub. Date: Jun. 22, 2023

(54) METHOD OF PREPARING A COPPER-PROMOTED ZEOLITE

(71) Applicant: BASF CORPORATION, Florham Park, NJ (US)

(72) Inventors: Wen-Mei XUE, Iselin, NJ (US); Ahmad MOINI, Iselin, NJ (US); Ivan PETROVIC, Iselin, NJ (US)

(21) Appl. No.: 18/000,301

(22) PCT Filed: Jun. 24, 2021
(86) PCT No.: PCT/US2021/038875

§ 371 Date: Nov. 30, 2022

Related U.S. Application Data
(60) Provisional application No. 63/044,198, filed on Jun. 25, 2020.

(51) Int. Cl. B01D 53/94; B01J 29/72; B01J 37/00; B01J 29/76

(52) U.S. Cl. CPC B01D 53/9418; B01J 29/723; B01J 37/0009; B01J 29/763; B01D 2255/20761; B01D 2255/50

(57) ABSTRACT

The present disclosure provides a method for preparing a selective catalytic reduction (SCR) catalyst, the SCR catalyst comprises a metal ion-exchanged zeolite. A method uses an in-situ ion exchange process. A process includes admixing a zeolite in the ammonium (NH₄⁺) form with an aqueous mixture comprising water, a transition metal ion source, and, optionally, an acid, to form a slurry containing a metal ion-exchanged zeolite.

This application claims priority to U.S. Provisional Application No. 63/044,198, filed Jun. 25, 2020; the contents of which is incorporated herein by reference in its entirety.

The present disclosure relates generally to the field of exhaust gas treatment catalysts, such as, metal-promoted zeolite catalysts for selectively reducing nitrogen oxides in engine exhaust, and to methods for preparing such catalysts.

Over time, the harmful components of nitrogen oxides (NOₓ) have led to atmospheric pollution. NOₓ is contained in exhaust gases, such as from internal combustion engines (e.g., in automobiles and trucks), from combustion installations power stations heated by natural gas, oil, or coal), and from nitric acid production plants.

Various treatment methods have been used for the treatment of NOₓ-containing gas mixtures to decrease atmospheric pollution. One type of treatment involves catalytic reduction of nitrogen oxides. There are two processes: (1) a nonselective reduction process wherein carbon monoxide, hydrogen, or a lower molecular weight hydrocarbon is used as a reducing agent; and (2) a selective reduction process wherein ammonia or an ammonia precursor is used as a reducing agent. In the selective reduction process, a high degree of nitrogen oxide removal can be achieved with a stoichiometric amount of reducing agent.

The selective reduction process is referred to as a SCR (Selective Catalytic Reduction) process. The SCR process uses catalytic reduction of nitrogen oxides with a reductant (e.g., ammonia) in the presence of atmospheric oxygen, resulting in the formation predominantly of nitrogen and steam:

4NO+4NH₃+O₂→4N₂+6H₂O (standard SCR reaction)

2NO₂+4NH₃+O₂→3N₂+6H₂O (slow SCR reaction)

NO−NO₂+2NH₃→2N₂+3H₂O (fast SCR reaction)

Catalysts employed in the SCR process may retain good catalytic activity over a wide range of temperature conditions of use, for example, 200° C. to 600° C. or higher, under hydrothermal conditions. SCR catalysts are commonly employed in hydrothermal conditions, such as during the regeneration of a soot filter, a component of the exhaust gas treatment system used for the removal of particles.

Current catalysts employed in the SCR process include metal-promoted zeolites, which have been used in SCR of nitrogen oxides with a reductant such as ammonia, urea, or a hydrocarbon in the presence of oxygen. Various metal-promoted zeolites SCR catalysts and methods of their preparation are known. To prepare a metal-promoted zeolite, generally, a base metal (e.g., a transition metal, such as copper, iron, or the like) is ion-exchanged into the zeolite by subjecting the ammonium (NH₄^{×}) form of the zeolite and a metal precursor (e.g., a soluble metal salt) to ion exchange in solution. This process is referred to as liquid-phase ion exchange (LPIE). See, e.g., U.S. Pat. No. 8,293,199, incorporated by reference herein in its entirety, which discloses the LPIE process. The ion exchange step is generally followed by filtration, washing, and drying of the ion-exchanged zeolite. This metal ion exchange process is labor and time intensive. For example, performing the ion exchange reaction generally takes several hours, and the filtration and washing is time consuming. Controlling metal content (e.g., copper) of metal-promoted zeolites requires precise control of ion exchange process parameters such as metal precursor concentration, pH, temperature, washing process, and the like. Filtration and washing steps in such processes can generate a large volume of metal solution waste requiring disposal. For example, preparation of 100 grams of copper ion-exchanged zeolite may generate about 10 liters of copper waste solution. An alternative process (in-situ ion exchange; ISIE) may avoid some of these steps. ISIE uses the hydrogen form of a zeolite rather than the NH₄⁺ form, Such a process is described, e.g., in US2019/0322537 to Kim et al., which is incorporated by reference herein in its entirety. However, preparing the hydrogen form of a zeolite requires the additional step of calcining the NH₄⁺ form. This high-temperature calcination process is costly due to the energy requirement. Further, there is the potential for zeolite de-alumination to occur during the calcining. Accordingly, there remains a need in the art to provide improved metal ion exchange processes for preparing metal-promoted zeolite SCR catalysts which avoid some of the liabilities of prior processes.

The present disclosure generally relates to an in-situ ion exchange (ISIE) process for preparing selective catalytic reduction (SCR) catalysts, The present disclosure provides a simple and rapid method to exchange transition metal (e.g., copper) ions into a zeolite. Surprisingly, certain embodiments of the method facilitate precise control of transition metal loading, obviate the filtration and washing steps required in the conventional liquid-phase ion exchange (LPIE) process, and eliminate or reduce metal solution waste, while providing SCR catalysts with activity comparable to conventionally prepared catalysts.

Accordingly, in one embodiment is provided a process for preparing a SCR catalyst comprising a transition metal ion-exchanged zeolite, the process comprising: (i) admixing a zeolite in the ammonium (NEW) form with an aqueous mixture comprising water, a transition metal ion source, and optionally an acid, to form a. slurry comprising a transition metal ion-exchanged zeolite.

In some embodiments, the transition metal is copper, manganese, iron, or a combination thereof. In some embodiments, the transition metal ion source is an oxide, nitrate, chloride, sulfate, acetate, hydroxide, oxalate, acetylacetonate, or carbonate salt of the transition metal. In some embodiments, the transition metal ion source is copper oxide (CuO).

In some embodiments, the acid is acetic acid.

In some embodiments, the zeolite has a framework type selected from the group consisting of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, CHI, CLO, CON, CZP, DAC, DDR, DFO, DIT DOH, DON, EAB, EDI, EH, EMT, EON, EPL ERI, ESV, ETR, ELIO, EZT, FAU, FER, FRA, GIS, GIU, GME, GON, GOO, HEU, IFR, IFY, IHV, IMF, IRN, ISV, ITE, ITG, ITH, ITW, IWIR, IWS, IWV, IWW, JBW, JRY, KFI, LAU, LEV, LIO, LIT, LOS, LOV, LTA, LTF, LTL, LTN, MAR, MAZ, MEI, MEL, MEP, MER, MFI, MFS, MON, MOR, MOZ, MRE, MSE, MSO, MTF, MTN, MTT, MVY, MTW, MWF, MWW, NAB, NAT, NES, NON, NPO, NPT, NSI, OBW, OFF, OKO, OSI, OSO, OWE, PAR, PAU, PCR, PHI, PON, PUN, RHO, RON, RRO, RSN, RTE, RTH, RUT, RWR, RWY, SAF, SAO, SAS, SAT, SAV, SBE, SBS, SBT, SCO, SEW, SFE, SFF, SFG, SFH, SFN, SFO, SFS, SFW, SGF, SGT, SIV, SOD, SOF, SOS, SSF, SSY, STF, STI, STO, STT, STW, SVR, SZR, TER, THO, TON, TSC, TUN, UEI, UFI, UOS, UOZ, USI, UTL, UWY, VET, VFI, VNI, VSV, WIE, WEN, YUG, ZON, and mixtures or intergrowths thereof. In some embodiments, the zeolite has a framework type selected from the group consisting of CHA and AEI. In some embodiments, the zeolite has a CHA framework type.

In some embodiments, the zeolite is an aluminosilicate having a framework consisting of Si, Al, and O, wherein the molar ratio of SiO₂:Al₂O₃ in the framework is from about 2 to about 300, from about 10 to about 100, or from about 20 to about 50.

In some embodiments, the aqueous mixture further comprises a binder component. In some embodiments, the binder component comprises Al, Si, Ti, Zr, Ce, or a mixture of two or more thereof. In some embodiments, the binder component is zirconium acetate.

In some embodiments, the aqueous mixture further comprises one or more additives selected from a sugar, a dispersing agent, a surface tension reducer, a rheology modifier, or a combination thereof.

In some embodiments, the admixing occurs for a period of time from about 1 hour to about 48 hours, or from about 12 to about 24 hours, or for at least about 12 hours or at least about 18 hours.

In some embodiments, the admixing is conducted at a temperature of from about 10 to about 50° C., or from about 15 to about 25° C.

In some embodiments, the process further comprises milling the aqueous mixture prior to or during the admixing.

In some embodiments, the process further comprises adding a refractory metal oxide support material to the slurry following the admixing.

In some embodiments, the process further comprises (ii) contacting a substrate with the slurry comprising the metal ion-exchanged zeolite to form a coating on the substrate, the substrate comprising an inlet end, an outlet end, an axial length extending from the inlet end to the outlet end, and a plurality of passages defined by internal walls of the substrate extending therethrough; (iii) drying the coated substrate; (iv) calcining the coated substrate obtained in (iii); and (v) optionally, repeating (ii) through (iv) one or more times; wherein the slurry is not filtered or washed prior to the contacting of (ii).

In some embodiments, the drying is performed at a temperature of from about 100 to about 150° C.

In some embodiments, the calcination is performed at a temperature of from about 400 to about 600° C.

In some embodiments, the substrate is a flow-through or a wall-flow filter.

In some embodiments, the amount of transition metal comprised in the transition metal ion-exchanged zeolite is in the range of from about 2 to about 10 wt %, about 2.5 to about 5.5 wt %, or about 3 to about 5 wt %, based on the weight of the transition metal ion-exchanged zeolite and calculated as the transition metal oxide.

### BRIEF DESCRIPTION OF THE DRAWINGS

In order to provide an understanding of embodiments of the disclosure, reference is made to the appended drawings, in which reference numerals refer to components of exemplary embodiments of the disclosure. The drawings are exemplary only, and should not be construed as limiting the disclosure. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A is a perspective view of a honeycomb-type substrate;

FIG. 1B is a partial cross-sectional view enlarged relative to FIG. 1A and taken along a plane parallel to the end faces of the substrate of FIG. 1A, which shows an enlarged view of a plurality of the gas flow passages shown in FIG. 1A, in an embodiment wherein the substrate is a flow-through substrate;

FIG. 2 is a cutaway view of a representative wall-flow filter;

FIG. 3 is a bar graph of NOx conversion at various temperature for an embodiment of the disclosure;

FIG. 4A is a plot of NOx conversion versus temperature for an embodiment of the disclosure after aging at 650° C.;

FIG. 4B is a plot of NOx conversion versus temperature for an embodiment of the disclosure after aging at 800° C.;

FIG. 5A is a plot of NOx conversion versus temperature for an embodiment of the disclosure after aging at 650° C.; and

FIG. 5B is a plot of NOx conversion versus temperature for an embodiment of the disclosure after aging at 800° C.

The present disclosure generally relates to a process for preparing selective catalytic reduction (SCR) catalyst compositions. Surprisingly, it was found according to the present disclosure that the in-situ ion exchange (ISIE) process disclosed herein advantageously provides precise control of copper loading, simplifies the overall process, and eliminates copper solution waste.

### DEFINITIONS

The articles “a” and “an” herein refer to one or to more than one (e.g. at least one) of the grammatical object. Any ranges cited herein are inclusive.

As used herein, the term “about” refers to ±5%. All numeric values are modified by the term “about” whether or not explicitly indicated. Numeric values modified by the term “about” include the specific identified value. For example, “about 5.0” includes 5.0. Recitation of ranges of values herein are merely intended to serve as a shorthand method of referring individually to each separate value falling within the range, unless otherwise indicated herein, and each separate value is incorporated into the specification as if it were individually recited. herein.

“Average particle size” is synonymous with D₅₀, meaning half of the population of particles has a particle size above this point, and half below. Particle size refers to primary particles. Particle size may be measured by laser light scattering techniques, with dispersions or dry powders, for example according to ASTM method D4464. D₉₀ particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

As used herein, the term “BET surface area” has its usual meaning of referring to the Brunauer, Emmett, Teller method for determining surface area by N₂ adsorption. Pore diameter and pore volume can also he determined using BET-type N₂ adsorption or desorption experiments.

The term “catalyst” refers to a material that promotes a chemical reaction. The catalytically active species are also termed “promoters” as they promote chemical reactions.

The term “catalytic article” or “catalyst article” refers to a component that is used to promote a desired reaction. The present catalytic articles comprise a “substrate” having at least one catalytic coating disposed thereon.

As used herein, “impregnated” or “impregnation” refers to permeation of the catalytic material into the porous structure of the support material.

As used herein, the phrase “molecular sieve” refers to framework materials such as zeolites and other framework materials (e.g., isomorphously substituted materials), which may in particulate form, and in combination with one or more promoter metals, be used as catalysts. Molecular sieves are materials based on an extensive three-dimensional network of oxygen ions containing generally tetrahedral type sites and having a substantially uniform pore distribution, with the average pore size being no larger than 20 Å.

Molecular sieves can he differentiated mainly according to the geometry of the voids which are formed by the rigid network of the (SiO₄)/AlO₄ tetrahedra. The entrances to the voids are formed from 6, 8, 10, or 12 ring atoms with respect to the atoms which form the entrance opening. Molecular sieves are crystalline materials having rather uniform pore sizes which, depending upon the type of molecular sieves and the type and amount of cations included in the molecular sieves lattice, range from about 3 to 10 Å in diameter. CHA is an example of an “8-ring” molecular sieve having 8-ring pore openings and double-six ring secondary building units and having a cage like structure resulting from the connection of double six-ring building units by 4 ring connections. Molecular sieves comprise small pore, medium pore and large pore molecular sieves or combinations thereof. The pore sizes are defined by the largest ring size.

The term “NO,” refers to nitrogen oxide compounds, such as NO, NO₂ or N₂O.

As used herein, the term “promoted” refers to a component that is intentionally added. to, e.g., a zeolitic material, typically through ion exchange, as opposed to impurities inherent in the zeolite. A zeolite may, for example, be promoted with copper (Cu) and/or iron (Fe), although other catalytic metals could be used, such as manganese, cobalt, nickel, cerium, platinum, palladium, rhodium, or combinations thereof

As used herein, the term “selective catalytic reduction” (SCR) refers to the catalytic process of reducing oxides of nitrogen to dinitrogen (N₂,) using a nitrogenous reductant.

As used herein, the term “substrate” refers to the monolithic material onto which the catalyst composition, that is, catalytic coating, is disposed, typically in the form of a washcoat. In one or more embodiments, the substrates are flow-through monoliths and monolithic wall-flow filters. Reference to “monolithic substrate” means a unitary structure that is homogeneous and continuous from inlet to outlet.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

“Washcoat” has its usual meaning in the art of a thin, adherent coating of a material (e.g., a catalyst) applied to a “substrate”, such as a honeycomb flow-through monolith substrate or a filter substrate which is sufficiently porous to permit the passage therethrough of the gas stream being treated. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A washcoat is formed by preparing a slurry containing a specified solids content (e.g., 10-50% by weight) of catalyst in a liquid, which is then coated onto a substrate and dried to provide a washcoat layer. A substrate can contain one or more washcoat layers, and each washcoat layer can be different in some way (e.g., may differ in physical properties thereof such as, for example particle size or crystallite phase) and/or may differ in the chemical catalytic functions.

Unless otherwise indicated, all parts and percentages are by weight, “Weight percent (wt %),” if not otherwise indicated, is based on an entire composition free of any volatiles, that is, based on dry solids content.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

All U.S. patent applications, published patent applications and patents referred to herein are hereby incorporated by reference,

### 1. Process for Preparing a SCR Catalyst

In one embodiment of the disclosure is provided a process for preparing a selective catalytic reduction (SCR) catalyst, said SCR catalyst comprising a transition metal ion-exchanged zeolite. The process comprises admixing a zeolite in the ammonium (NH₄⁺) form with an aqueous mixture comprising water, an acid, and a transition metal ion source for a period of time to form a slurry comprising a transition metal ion-exchanged zeolite. The individual components of the aqueous mixture are described in detail herein below.

### Zeolite

Zeolites are microporous solids containing pores and channels of various dimensions. As used herein, the term “zeolite” refers to a specific example of a molecular sieve, further including silicon and aluminum atoms. Generally, zeolites have an open 3-dimensional framework structure composed of corner-sharing TO₄ tetrahedra, where T is Al or Si, or optionally P. The SiO₄/AlO₄ tetrahedra are linked by common oxygen atoms to form a three-dimensional network, Aluminosilicate zeolite structures do not include phosphorus or other metals isomorphically substituted in the framework. That is, “aluminosilicate zeolite” excludes aluminophosphate materials such as SAPO, AlPO and MeAlPO materials, while the broader term “zeolite” includes aluminosilicates and aluminophosphates. In some embodiments, the zeolite material is an alurninosilicate zeolite.

Because of the presence of 2- or 3-valent cations as tetrahedron centers in the zeolite skeleton, the zeolite receives a negative charge in the form of so-called anion sites in whose vicinity the corresponding cation positions are located. The negative charge is compensated for by incorporating cations into the pores of the zeolite material. Cations that balance the charge of the anionic framework are loosely associated with the framework oxygen atoms and the remaining pore volume is filled with water molecules. A wide variety of cations can occupy these pores and can move through these channels. The non-framework cations are generally exchangeable, and the water molecules removable. “Exchange sites” refers to sites available for cations, which are mainly occupied by ion-exchanged metal cations (e.g., transition metal cations such as Cu or Fe), which are intentionally added to the zeolite in order to promote a chemical reaction.

According to one or more embodiments, the zeolite can be based on the framework topology by which the structures are identified. Typically, any structure type of zeolite can be used in the process, such as structure types of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DOH, DON, EAB, EDI, EMT, EON, EPI, ERI, ESV, ETR, EUO, FAU, FER, FRA, GIU, GME, GON, GOO, HEU, IFR, IHW, ISV, ITE, ITH, ITW, IWR, IWW, JBW, KFI, LAU, LEV, LIO, LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWW, NAB, NAT, NES, NON, NPO, NSI, OBW, OFF, OSI, OSO, OWE, PAR, PAU, PHI, PON, RHO, RON, RRO, RSN, RTE, RUT, RWR, RWY, SAO, SAS, SAT, SAV, SBE, SBS, SBT, SFE, SFG, SFH, SFN, SFO, SGT, SOD, SOS, SSY, STF, STI, STT, TER, THO, TON, TSC, UEL, UFI, UOZ, USI, UTL, VET, VFI, VNI, VSV, WIE, WEN, YUG, ZON, or combinations thereof Present zeolites may be small pore, medium pore, or large pore zeolites.

A small pore zeolite contains channels defined by up to eight tetrahedral atoms. As used herein, the term “small pore” refers to pore openings which are smaller than about 5 Angstroms, for example on the order of ˜3,8 Angstroms. Example small pore zeolites include framework types ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures or intergrowths thereof. In some embodiments, the zeolite is a small pore zeolite.

A medium pore zeolite contains channels defined by ten-membered rings. Example medium pore zeolites include framework types AEL, AFO, AHT, BOF, BOZ, CGF, CGS, CHI, DAC, EUO, FFR, HEU, IMF, ITH, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN and mixtures or intergrowths thereof.

A large pore zeolite contains channels defined by twelve-membered rings. Example large pore zeolites include framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and mixtures or intergrowths thereof.

In some embodiments, the zeolite has a structure type selected from the group consisting of AEI, AFT, AFX, CHA, EAB, ERI, KFI, LEV, LTN, MSO, SAS, SAT, SAV, SFW, and TSC. In some embodiments, the zeolite has a framework structure type selected from the group consisting of CHA, AEI, AFX, a mixture of two or more thereof, and a mixed type of two or more thereof. In some embodiments, the zeolite has a framework structure type selected from the group consisting of CHA and AEI. In some embodiments, the zeolite has a framework type CHA. Specific zeolites having the CHA structure that are useful in the present disclosure include, but are not limited to SSZ-13, SSZ-62, natural chabazite, zeolite K-G, Linde D, Linde R, LZ-218, LZ-235, LZ-236, ZK-14, SAPO-34, SAPO-4, SAP0-47, and ZYT-6. In some embodiments, the zeolite having the CHA crystal structure is an aluminosilicate zeolite. In some embodiments, the aluminosilicate zeolite is SSZ-13.

The molar ratio of silica-to-alumina (“SAR”) of a present zeolite can vary over a wide range, but is generally 2 or greater. For instance, a present zeolite may have a SAR of from about 5 to about 1000. In one or more embodiments, the zeolite has a silica-to-alumina (SAR) molar ratio in the range of 2 to 300, including 5 to 250; 5 to 200; 5 to 100; and 5 to 50. In some embodiments, the zeolite has a SAR in the range of 10 to 200, 10 to 100, 10 to 75, 10 to 60, and 10 to 50; 15 to 100, 15 to 75, 15 to 60, and 15 to 50; 20 to 100, 20 to 75, 20 to 60, and 20 to 50. In some embodiments, the molar ratio of silica to alumina (SiO₂:Al₂O₃), is from about 2 to about 50. In some embodiments, the molar ratio of SiO₂ to Al₂O₃ is about 25.

The particle size of the zeolite can vary. Generally, the particle size of the zeolite can be characterized by a D₉₀ particle size of about 1 to about 40 micrometers, from about 1 to about 20 micrometers, or from about 1 to about 10 micrometers. In some embodiments, the zeolite comprises particles having a D₅₀ value of from about 1 to about 5 micrometers, and a D₉₀ value of from about 4 to about 10 micrometers.

The present zeolites may exhibit a high surface area, for example a BET surface area, determined according to DIN 66131, of at least about 200 m²/g, at least about 400 m²/g, at least about 500 m²/g, or at least about 750, or at least about 1000 m²/g, for example from about 200 to about 1000 m²/g, or from about 500 to about 750 m²/g. In one or more embodiments the BET surface area is from about 550 to about 700 m²/g.

### Transition Metal Ion Source

As disclosed herein, the process for preparing a SCR catalyst includes a transition metal ion source. By “transition metal” is meant any of the set of metallic elements occupying a central block (Groups IVB-VIII, IB, and IIB or 4-12) in the periodic table. Examples of suitable transition metals include vanadium (V), titanium (Ti), copper (Cu), iron (Fe), cobalt (Co), nickel (Ni), chromium (Cr), manganese (Mn), zinc (Zn), molybdenum (Mo), tin (Sn), or silver (Ag), or combinations thereof, that are catalytically active for reduction of NOx. In some embodiments, the transition metal is copper, manganese, iron, or a combination thereof.

The term “ion source” refers to a compound, complex, salt, or the like which provides, under aqueous conditions, ions of the transition metal which may then diffuse and enter the exchange sites of the zeolite as described herein above. In some embodiments, the transition metal ion source is an oxide, nitrate, chloride, sulfate, acetate, hydroxide, oxalate, acetylacetonate, or carbonate salt of the transition metal. In some embodiments, the transition metal ion source comprises one or more of copper oxide, copper hydroxide, copper carbonate, copper nitrate, copper chloride, copper acetate, copper acetylacetonate, copper oxalate, or copper sulfate. In some embodiments, the transition metal ion source is a copper carbonate. In some embodiments, the transition metal ion source is basic copper carbonate (Cu(OH)₂·Cu(CO₃)). In some embodiments, the transition metal ion source is copper oxide (CuO). Without wishing to be bound by theory, it is believed that copper sources having low solubility (e.g., CuO) provide a copper ion-exchanged zeolite with superior catalytic activity (e.g., high temperature NOx conversion) relative to a copper ion-exchanged zeolite prepared from a highly soluble copper salt (e.g., copper acetate). Particularly, according to the present disclosure, it was found that a copper ion-exchanged zeolite prepared from copper acetate according to the method disclosed herein, gave inferior results for high temperature NOx conversion. Again without wishing to be bound by theory, it is believed that copper acetate precipitates on the zeolite surface during the ion exchange reaction, leading to reduced catalytic activity.

In some embodiments, the zeolite can be ion-exchanged with copper. In some embodiments, the zeolite can be ion-exchanged with iron. In sonic embodiments, the zeolite can be ion-exchanged with both copper and iron. Where both transition metals are to be included in the transition metal ion-exchanged zeolite, multiple transition metal precursors (e.g., copper and iron precursors) can be ion-exchanged at the same time. In some embodiments, copper and iron are exchanged into the zeolite simultaneously (i.e., the transition metal ion source is a mixture of a copper salt and an iron salt, such as copper oxide and an iron oxide.

### Acid

The process as disclosed herein may be performed under acidic conditions. A typical pH range for the slurry is from about 3 to about 6. Addition of acidic or basic species to the slurry can be carried out to adjust the pH accordingly. For example, in some embodiments, the pH of the slurry is adjusted by the addition of an aqueous acid, particularly carboxylic acids such as formic acid, acetic acid, propanoic acid, or butanoic acid. In some embodiments, the acid is acetic acid.

### Binder Component

In sonic embodiments, the process further comprises adding a binder component during the admixing step. The term “binder component” refers to a binder or a precursor thereof which converts to the desired binder upon calcination. Binders provide a catalyst that remains homogeneous and intact after thermal aging, for example, when the catalyst is exposed to high temperatures of at least about 600° C., for example, about 800° C. and higher, and high water vapor environments of about 5% or more. In some embodiments, the binder component comprises Al, Si, Ti, Zr, Ce, or a mixture of two or more thereof. In some embodiments, the binder comprises alumina, silica, titania, zirconia, ceri a, or a mixture or mixed oxide of two or more thereof In some embodiments, the binder is zirconia (ZrO₂). In some embodiments, the binder component is any suitable zirconia precursor, such as zirconyl acetate or zirconyl nitrate.

The particle size of the binder may vary. Generally, the particle size of the binder can be characterized by a D₉₀ particle size of about 0.1 to about 40 micrometers, from about 0.1 to about 30 micrometers, or from about 0.1 to about 25 micrometers. In some embodiments, the binder comprises particles having a D₉₀ value of from about 0.5 to about 20 micrometers.

The binder may exhibit a high surface area, for example a BET surface area, determined. according to DIN 66131, of at least about 200 m²/g, at least about 400 m²/g, at least about 500 m²/g, at least about 750, or at least about 1000 m²/g, for example from about 200 to about 1000 m²/g, or from about 500 to about 750 m²/g. In one or more embodiments the BET surface area. of the binder is from about 550 to about 700 m²/g.

### Additives

The slurry may optionally contain various additional components (i.e., additives). Typical additional components include, but are not limited to, additives to control, e.g., viscosity of the slurry. Additional components can include water-soluble or water-dispersible stabilizers (e.g., barium acetate), promoters (e.g., lanthanum nitrate), thickeners, surfactants (including anionic, cationic, non-ionic or amphoteric surfactants), dispersing agents, surface tension modifiers, sugars, rheology modifiers, or combinations thereof The properties of the slurry may vary depending on intended usage. For example, the solids content of the slurry may vary. In some embodiments, the slurry has a solid content of from about 15 to about 45 wt %, based on the weight of said slurry.

### Admixing

The process as disclosed herein comprises admixing a zeolite in the ammonium form with an aqueous mixture comprising water, an optional acid, and a transition metal ion source to form a slurry comprising a transition metal ion-exchanged zeolite. The admixing step promotes the ion exchange reaction of the transition metal ion source with the zeolite. Without wishing to be bound by theory, it is believed that the ion exchange process at least begins during the admixing step, and the resulting slurry comprises an amount of metal ion-exchanged zeolite. The ion exchange process initiated in the admixing step may, however, proceed further during e.g., calcination or subsequent treatment steps.

The time period for admixing may vary, but is generally conducted for a time period sufficient to allow substantially all of the transition metal ion source to enter the exchange sites of the zeolite. For example, in some embodiments, the admixing occurs for a period of time from about 1 hour to about 48 hours, or from about 12 to about 24 hours, or for at least about 12 hours or at least about 18 hours, In some embodiments, the time period is about 24 hours. In some embodiments, the time period is about 6 hours or longer, about 12 hours or longer, about 18 hours or longer, or about 24 hours or longer.

The admixing step can be carried out at various temperatures, for example, at a temperature of about 10° C. to about 50° C., such as from about 10, about 15, or about 20, to about 25, about 30, about 35, about 40, about 45, or about 50° C. In certain embodiments, the temperature can be from about 15° C. to about 25° C., for example, about 20° C.

### Milling

In some embodiments, the method further comprises milling the aqueous mixture prior to or during the admixing step. In some embodiments, the slurry is milled to provide a particular particle size range, to enhance mixing of the particles, or to form a homogenous material. The milling can be accomplished in a ball mill, continuous mill, or other similar equipment. In some embodiments, the particles of the components present in the slurry (e.g., zeolite, transition metal ion source, binder, and the like) have a D₉₀ value of from about 0.5 to about 20 micrometers.

### Transition Metal Ion-Exchanged Zeolite

Following the admixing, and optionally, the milling, the slurry contains the zeolite in transition metal ion-exchanged form. In the present process, the zeolite, prior to admixing with the aqueous mixture, is in the ammonium ion (NH₄⁺) form, meaning the ion exchange sites are occupied with NH₄⁺ cations, which are replaced with transition metal cations during the process. The transition metal ions diffuse into the pores of the zeolite and exchange with the residing ions, i.e., NH₄⁺, to form the transition metal ion-exchanged zeolite. By “transition metal ion exchanged” it is meant that at least a portion of the zeolite ion exchange sites are occupied by transition metal ions. For example, more than 50% of the exchange sites are exchanged in some embodiments, and more particularly, more than 70% of the exchange sites are exchanged with the desired transition metal ion in certain embodiments. Reference to “transition metal ions” in this context allows for the presence of the transition metal in any valence state. For example, a portion or all of the transition metal promoting the zeolite may be in an ionic form, or in an oxide form. Generally, a portion or even all of the transition metal exchanged in the zeolite will be present in an oxide form following calcination and/or exposure of the catalyst to normal operating conditions.

The amount of metal ion-exchanged in the metal ion-exchanged zeolite may vary. The transition metal content of the zeolitic material, calculated as the oxide, is, in one or more embodiments, at least about 0.1 wt %, reported on a volatile-free basis. In some embodiments, the amount of metal comprised in the metal ion-exchanged zeolite is in the range of from about 1 to about 15 wt %, about 2 to about 10 wt %, about 2.5 to about 5.5 wt %, about 3 to about 5 wt %, or about 3.5 to about 4 wt %, based on the weight of the metal ion-exchanged zeolite and calculated as the metal oxide. In one or more embodiments, the transition metal is present in an amount in the range of about 1 to about 10% by weight, including the range of about 2 to about 6% by weight, and the range of about 4 to about 6% by weight, in all cases, based on the total weight of the zeolitic material. In one or more specific embodiments, the transition metal comprises Cu, and the Cu content, calculated as CuO, is in the range of up to about 10 wt %, including 9, 8, 7, 6, 5, 4, 3, 2, 1, 0.5, and 0.1 wt %, on an oxide basis, in each case based on the total weight of the calcined zeolitic material and reported on a volatile free basis. In specific embodiments, the Cu content, calculated as CuO, is in the range of about 3 to about 5 wt %.

### II. Process for Preparing SCR Catalytic Articles

In some embodiments, the process for preparing a selective catalytic reduction (SCR) catalyst as disclosed herein further comprises steps directed to the preparation of SCR catalyst articles comprising a substrate and the transition metal ion-exchanged zeolite prepared as disclosed herein. The process and components thereof are described in further detail herein below.

### Refractory Metal Oxide Support

In some embodiments, the process for preparing a SCR catalyst as disclosed herein further comprises adding a refractory metal oxide support material to the slurry, Refractory metal oxides exhibit chemical and physical stability at high temperatures, such as the temperatures associated with gasoline or diesel engine exhaust. Examples of suitable refractory metal oxides include alumina, silica, zirconia, titania, ceria, praseodymia, tin oxide and the like, as well as physical mixtures or chemical combinations thereof, including atomically-doped combinations and including high surface area or activated compounds such as activated alumina. High surface area metal oxide supports have pores larger than 20 Å and a wide pore distribution. High surface area metal oxide supports such as alumina support materials, also referred to as “gamma alumina” or “activated alumina,” typically exhibit a BET surface area in excess of 60 m²/g, often up to about 200 m²/g or higher. An example refractory metal oxide comprises high surface area γ-alumina having a specific surface area of about 50 to about 300 m²/g. Such activated alumina is usually a mixture of the gamma and delta phases of alumina, but may also contain substantial amounts of eta, kappa and theta alumina phases.

The refractory metal oxide supports are, such as, gamma alumina, silica-alumina, ceria coated on alumina, titania coated on alumina or zirconia coated on alumina. Included are combinations of metal oxides such as silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia alumina and alumina-ceria. Example aluminas include large pore boehmite, gamma-alumina, and delta/theta alumina. Useful commercial aluminas used as starting materials in certain processes include activated aluminas, such as high bulk density gamma-alumina, low or mediwn bulk density large pore gamma-alumina and low bulk density large pore boehmite and gamma-alumina. In some embodiments, the refractory metal oxide comprises silica, alumina, ceria, zirconia, ceria-zirconia composite, titania, or combinations thereof In some embodiments, the refractory metal oxide is boehmite, gamma-alumina, or delta/theta alumina.

### Substrate Coating Process

In one or more embodiments, the present SCR catalyst comprising a transition metal ion-exchanged zeolite, is disposed on a substrate to form a SCR catalyst article. Catalytic articles comprising the substrates are generally employed as part of an exhaust gas treatment system (e.g., catalyst articles including, but not limited to, articles including the SCR catalyst disclosed herein). Accordingly, in some embodiments, the process as disclosed herein further comprises:
(ii) contacting a substrate with the slurry comprising the metal ion-exchanged zeolite to form a coating on the substrate, wherein the substrate comprises an inlet end, an outlet end, an axial length extending from the inlet end to the outlet end, and a plurality of passages defined by internal walls of the substrate extending therethrough;
(iii) drying the coated substrate;
(iv) calcining the coated substrate obtained in (iii); and
(v) optionally, repeating (ii) through (iv) one or more times.

The term “contacting” refers to a substrate as described herein that is contacted with the slurry comprising the metal ion-exchanged zeolite to provide a coating (i.e., the slurry is disposed on a substrate), typically using any washcoat technique known in the art. The washcoated substrate is then dried and calcined to provide a coating layer. If multiple coatings are applied, the substrate is dried and/or calcined after each washcoat is applied and/or after the number of desired multiple washcoats are applied. In some embodiments, no additional steps are performed between forming the slurry containing the zeolite in transition metal ion-exchanged form and the step of contacting the substrate with the slurry. Accordingly, in some embodiments, the slurry comprising the transition metal ion-exchanged zeolite is directly used for coating the substrate with no further intervening processing steps. In some embodiments, the disclosed method is advantageous relative to traditional processes which require additional processing steps, such as filtration, washing, drying, re-slurrying, and the like. In some embodiments, the disclosed process avoids energy intensive steps such as calcining of an ammonium form of zeolite, or intermediate drying of the ion-exchanged zeolite. In some embodiments, the disclosed method is advantageous relative to traditional processes in reducing the quantity of water used, reducing the quantity of hazardous metal waste produced, reducing the amount of time required for the process, reducing the labor required for the process, or a combination thereof In some embodiments, the disclosed method is advantageous relative to traditional processes in avoiding the need for precise control of ion exchange process parameters such as metal precursor concentration, temperature, washing process, and the like, while providing a product (transition metal ion-exchanged zeolite, or coated substrate comprising the transition metal ion-exchanged zeolite) with substantially identical features and performance relative to the same products compared by conventional processes.

### Substrate

Useful substrates are 3-dimensional, having a length and a diameter and a volume, similar to a cylinder. The shape does not necessarily have to conform to a cylinder. Present substrates have an inlet end and an outlet end, and the length is an axial length defined by the inlet end and outlet end.

According to one or more embodiments, the substrate for the disclosed catalyst(s) may be constructed of any material typically used for preparing automotive catalysts and will typically comprise a metal or ceramic honeycomb structure. The substrate typically provides a plurality of passages defined by internal walls of the substrate extending therethrough and a plurality of wall surfaces upon which the washcoat composition is applied and adhered, thereby acting as a substrate for the catalyst.

Ceramic substrates may be made of any suitable refractory material, e.g., cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Substrates may also be metallic, comprising one or more metals or metal alloys. A metallic substrate may include any metallic substrate, such as those with openings or “punch-outs” in the channel walls. The metallic substrates may be employed in various shapes such as pellets, compressed metallic fibers, corrugated sheet or monolithic foam. Specific examples of metallic substrates include heat-resistant, base-metal alloys, especially those in which iron is a substantial or major component. Such alloys may contain one or more of nickel, chromium, and aluminum, and the total of these metals may advantageously comprise at least about 15 wt % (weight percent) of the alloy, for instance, about 10 to about 25 wt % chromium, about 1 to about 8 wt % of aluminum, and from 0 to about 20 wt % of nickel, in each case based on the weight of the substrate. Examples of metallic substrates include those having straight channels; those haying protruding blades along the axial channels to disrupt gas flow and to open communication of vas flow between channels; and those having blades and also holes to enhance gas transport between channels allowing for radial gas transport throughout the monolith.

Any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). Another suitable substrate is of the type have a plurality of fine, substantially parallel gas flow passages extending along the longitudinal axis of the substrate where, typically, each passage is blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. In some embodiments, the substrate is a flow-through substrate. Flow-through substrates and wall-flow filters will be further discussed herein below.

### Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which are essentially straight paths from their fluid inlet to their fluid outlet, are defined by walls on or in which a catalytic coating is disposed so that gases flowing through the passages contact the catalytic material. The flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

Flow-through substrates can, for example, have a volume of from about 50 in³ to about 1200 in³, a cell density (inlet openings) of from about 60 cells per square inch (cpsi) to about 500 cpsi or up to about 900 cpsi, for example from about 200 to about 400 cpsi and a wall thickness of from about 50 to about 200 microns or about 400 microns.

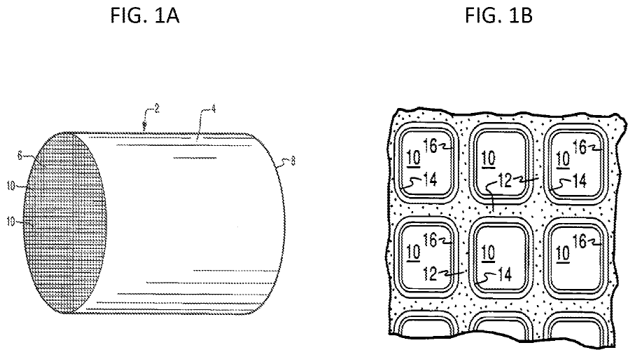

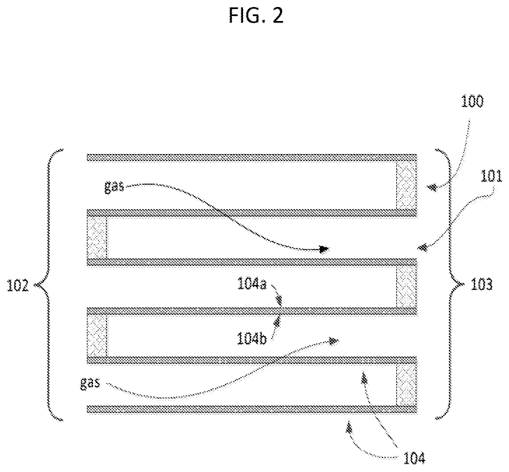

FIGS. 1A and 1B illustrate an exemplary substrate 2 in the form of a flow-through substrate coated with a catalyst composition as described herein. Referring to FIG. 1A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. In some embodiments, one or more (e.g., two, three, or four or more) catalyst composition layers may be used. Further coating configurations are disclosed herein below.

### Wall-Flow Filter Substrates

In some embodiments, the substrate is a wall-flow filter, which generally has a plurality of fine, substantially parallel gas flow passages extending along the longitudinal axis of the substrate. Typically, each passage is blocked at one end of the substrate body, with alternate passages blocked at opposite end-faces. Such monolithic wall-flow filter substrates may contain up to about 900 or more flow passages (or “cells”) per square inch of cross-section, although far fewer may be used. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes. The wall-flow filter substrate can be ceramic or metallic as described above.

A cross-section view of a monolithic wall-flow filter substrate section is illustrated in

FIG. 2, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

The wall-flow filter article substrate may have a volume of, for instance, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³. Wall-flow filter substrates typically have a wall thickness from about 50 microns to about 2000 microns, for example from about 50 microns to about 450 microns or from about 150 microns to about 400 microns.

The walls of the wall-flow filter may be porous and generally have a wall porosity of at least about 40% or at least about 50% with an average pore diameter of at least about 10 microns prior to disposition of the functional coating. For instance, the wall-flow filter article substrate in some embodiments will have a porosity of ≥40%. ≥50%, ≥60%, ≥65% or ≥70%. For instance, the wall-flow filter article substrate will have a wall porosity of from about 50%, about 60%, about 65% or about 70% to about 75% and an average pore diameter of from about 10, or about 20, to about 30, or about 40 microns prior to disposition of a catalytic coating. The terms “wall porosity” and “substrate porosity” mean the same thing and are interchangeable. Porosity is the ratio of void volume (or pore volume) divided by the total volume of a substrate material. Pore size and pore size distribution are typically determined by fig porosimetry measurement.

### Drying

Following the contacting, the substrate having applied thereon a washcoat of the slurry described herein, may be dried to remove excess moisture and volatile components. In some embodiments, the drying is performed at a temperature of from about 100° C. to about 150° C. In some embodiments, drying is performed in a gas atmosphere. In some embodiments, the gas atmosphere comprises oxygen. In some embodiments, the drying is performed for a duration of time in the range of from 10 minutes to 4 hours, more particularly in the range of from 20 minutes to 3 hours, or from 50 minutes to 2.5 hours.

### Calcination

Following the drying, the washcoated substrate may be calcinated. In some embodiments, the calcination is performed at a temperature of from about 300° C. to 900° C., from about 400° C. to about 650° C., or from about 450° C. to about 600° C. In some embodiments, the calcination is performed in a gas atmosphere. In some embodiments, the gas atmosphere comprises oxygen. In some embodiments, the calcination is performed for a duration of time in the range of from 10 minutes to about 8 hours, from about 20 minutes to about 3 hours, or from about 30 minutes to about 2.5 hours.

After calcining, the catalyst loading obtained by the above described washcoat technique can be determined through calculation of the difference in coated and uncoated weights of the substrate. As will be apparent to those of skill in the art, the catalyst loading can be modified by, for example, altering the slurry rheology. In addition, the coating/drying/calcining process to generate a washcoat layer (coating layer) can be repeated as needed to build the coating to the desired loading level or thickness, meaning more than one washcoat may he applied. The present SCR catalytic coating may comprise one or more coating layers, where at least one layer comprises the present SCR catalyst. The catalytic coating may comprise one or more thin, adherent coating layers disposed on and in adherence to least a portion of a substrate. The entire coating comprises the individual “coating layers”. In some embodiments, the catalyst washcoat loading is in the range of from about 0.8 g/in³ to 2.6 g/in³, from about 1.2 g/in³ to 2.2 g/in³, or from about 1.5 g/in³ to about 2.2 g/in³,

Following calcination, catalyst articles may he used “fresh,” meaning it is recently prepared and has not been exposed to high heat or thermal stress for a prolonged period of time. “Fresh” may also mean that the catalyst has not been exposed to any exhaust gases. Likewise, an “aged” catalyst article is not recently prepared and has been exposed to exhaust gases and/or elevated temperature (i.e., greater than 500° C.) for a prolonged period of time (i.e., greater than 3 hours).

### Additional Embodiments

Without limitation, some embodiments of the disclosure include:

1. A process for preparing a selective catalytic reduction catalyst comprising a transition metal ion-exchanged zeolite, wherein the process comprises
admixing an ammonium form zeolite in an aqueous mixture comprising a transition metal ion source, and, optionally, an acid, to form a slurry comprising a transition metal ion-exchanged zeolite.

2. The process of embodiment 1, wherein the transition metal is chosen from copper, manganese, iron, and combinations thereof.

3. The process of embodiment 1 or 2, wherein the transition metal ion source is a salt of the transition metal chosen from an oxide, nitrate, chloride, sulfate, acetate, hydroxide, oxalate, acetylacetonate, and carbonate.

4. The process of any one of embodiments 1-3, wherein the transition metal ion source is copper oxide.

5. The process of any one of embodiments 1-4, wherein the aqueous mixture comprises the acid and the acid is acetic acid.

6. The process of any one of embodiments 1-5, wherein the zeolite has a, framework type chosen from ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE,, BSV, CAN, CAS, CDO, CFI, CGF, CGS, CHA, CHI, CLO, CON, CZP, DAC, DDR, DFO, DFT, DOH, DON, EAB, EDI, EEI, EMT, EON, EPI, ERI, ESV, ETR, EUO, EZT, FAU, FER, FRA, GIS, GIU, GME, GON, GOO, HEU, IFR, IFY, IHW, IMF, IRN, ISV, ITE, ITG, ITH, ITW, IWR, IWS, IWV, IWW, JBW, JRY, JSR, JST, KFI, LAU, LEV, LIO, LIT, LOS, LOV, LTA, LTF, LTL, LTN, MAR, MAZ, MEI, MEL, MEP, MER, MFS, MON, MOR, MOZ, MRE, MSE, MSO, MTF, MTN, MTT, MVY, MTW, MWF, MWW, NAB, NAT, NES, NON, NPO, NPT, NSI, OBW, OFF, OKO, OSI, OSO, OWE, PAR, PAU, PCR, PHI, PON, PUN, RHO, RON, RRO, RSN, RTE, RTH, RUT, RWR, RWY, SAF, SAO, SAS, SAT, SAV, SBE, SBS, SBT, SCO, SEW, SFE, SFF, SFG, SFH, SFN, SFO, SFS, SFW, SGF, SGT, SIV, SOD, SOF, SOS, SSF, SSY, STF, STI, STO, STT, STW, SVR, SZR, TER, THO, TON, TSC, TUN, UEI, UFI, UOS, UOZ, USI, UTL, UWY, VET, VFI, VNI, VSV, WIE, WEN, YUG, ZON, and mixtures or intergrowths thereof.

7. The process of any one of embodiments 1-6, wherein the zeolite has a framework type chosen from CHA and AEI.

8. The process any one embodiments 1-7, wherein the zeolite has a. CHA framework type.

9. The process of any one of embodiments 1-8, wherein the zeolite is an aluminosilicate having a framework consisting of Si, Al, and O, wherein the molar ratio of SiO₂:Al₂O₃ in the framework is from about 2 to about 300, from about 10 to about 100, and/or from about 20 to about 50.

10. The process of any one of embodiments 1-9, wherein the aqueous mixture further comprises a binder component.

11. The process of embodiment 10, wherein the binder component comprises at least one chosen from Al, Si, Ti, Zr, Ce, and mixtures thereof.

12. The process of embodiment 10 or 11, wherein the binder component is zirconium acetate.

13. The process of any one of embodiments 1-12, wherein the aqueous mixture further comprises at least one additives chosen from a sugar, a dispersing agent, a surface tension reducer, a rheology modifier, and combinations thereof.

14. The process of any one of embodiments 1-13, wherein the admixing occurs for a period of time from about 1 hour to about 48 hours, and/or from about 12 to about 24 hours, and/or for at least about 12 hours and/or at least about 18 hours.

15. The process of any one of embodiments 1-14, wherein the admixing is conducted at a temperature from about 10° C. to about 50° C., and/or from about 15° C. to about 25° C.

16. The process of any one of embodiments 1-15, further comprising milling the aqueous mixture prior to and/or during the admixing.

17. The process of any one of embodiments 1-16, further comprising adding a refractory metal oxide support material to the slurry following the admixing.

18. The process of any one of embodiments 1-17, further comprising:

contacting a substrate with the slurry comprising the metal ion-exchanged zeolite to form a coating on the substrate, the substrate comprising an inlet end, an outlet end, an axial length extending from the inlet end to the outlet end, and a plurality of passages defined by internal walls of the substrate extending therethrough;
drying the coated substrate;
calcining the coated substrate; and
   optionally, repeating the contacting, drying, and calcining steps one or more times;
wherein the slurry is not filtered or washed prior to the contacting the substrate with the slurry.

19. The process of embodiment 18, wherein the drying is performed at a temperature from about 100° C. to about 150° C.

20. The process of embodiment 18 or 19, wherein the calcination is performed at a temperature from about 400° C. to about 600° C.

21. The process of any one of embodiments 18 to 20, wherein substrate is a flow-through substrate or a wall-flow filter.

22. The process of any one of embodiments 1-21, wherein the transition metal ion-exchanged zeolite has an amount of transition metal ranging about 2 wt % to about 10 wt %, about 2.5 wt % to about 5.5 wt %, and/or about 3 wt % to about 5 wt %, based on a weight of the transition metal ion-exchanged zeolite and calculated as a transition metal oxide.

23. The process of any one of embodiments 1-4 and 6-22, wherein the aqueous mixture comprises the acid.

24. The process of embodiment 5 or 23, wherein the slurry has an amount of the acid ranging from 0.01 wt % to 10 wt % by total weight of the slurry, 0.1 wt % to 10 wt % by total weight of the slurry, 1 wt % to 10 wt % by total weight of the slurry, and/or 0.1 wt % to 5 wt % by total weight of the slurry.

25. The process of any one of embodiments 1-24, wherein the slurry has an amount of the transition metal ion source ranging from 0.01 wt % to 10 wt % by total weight of the slurry, 0.1 wt % to 10 wt % by total weight of the slurry. 1 wt % to 10 wt % by total weight of the slurry, and/or 0.1 wt % to 5 wt % by total weight of the slurry.

26. The process of any one of embodiments 1-24, wherein, at the admixing step, a weight ratio of the ammonium form zeolite to the transition metal ion source ranges from 2:1 to 100:1, 2:1 to 50:1, 2:1 to 50:1, 5:1 to 50:1, and/or 10:1 to 30:1.

27. A selective catalytic reduction catalyst prepared according to the process of any one of embodiments 1-26.

28. A process for treating an exhaust gas comprising contacting the exhaust gas with the selective catalytic reduction catalyst of embodiment 27.

29. A process for preparing a transition metal ion-exchanged zeolite, wherein the process comprises admixing an ammonium form zeolite with an aqueous mixture comprising a transition metal ion source, and, optionally, an acid to form a slurry.

30. The process of embodiment 29, wherein the transition metal is chosen from copper, manganese, iron, and combinations thereof.

31. The process of embodiment 29 or 30, wherein the transition metal ion source is a salt of the transition metal chosen from an oxide, nitrate, chloride, sulfate, acetate, hydroxide, oxalate, acetylacetonate, and carbonate.

32. The process of any one of embodiments 29-31, wherein the transition metal ion source is copper oxide.

33. The process of any one of embodiments 29-32, wherein the aqueous mixture comprises the acid.

34. The process of any one of embodiments 29-33, wherein the zeolite has a framework type chosen from ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, CHI, CLO, CON, CZP, DAC, DDR, DFO, DFT, DOH, DON, EAB, EDI, EEI, EMT, EON, EPI, ERI, ESV, ETR, EUO, EZT, FAU, FER, FRA, GIS, GIU, GME, GON, GOO, HEU, IFR, IFY, IHW, IMF, IRN, ISV, ITE, ITG, ITH, ITW, IWR, IWS, IWV, IWW, JBW, JRY, JSR, JST, KFI, LAU, LEV, LIO, LIT, LOS, LOV, LTA, LTF, LTL, LTN, MAR, MAZ, MEI, MEL, MEP, MER, MFI, MFS, MON, MOR, MOZ, MRE, MSE, MSO, MTF, MTN, MTT, MVY, MTW, MWF, MWW, NAB, NAT, NES, NON, NPO, NPT, NSI, OBW, OFF, OKO, OSI, OSO, OWE, PAR, PAU, PCR, PHI, PON, PUN, RHO, RON, RRO, RSN, RTE, RUE, RTH, RUT, RWR, RWY, SAF, SAO, SAS, SAT, SAV, SBE, SBS, SBT, SCO, SEW, SFE, SFF, SFG, SFH, SFN, SFO, SFS, SFW, SGF, SGT, SIV, SOD, SOF, SOS, SSF, SSY, STF, STI, STO, STT, STW, SVR, SZR, TER, THO, TON, TSC, TUN, UEI, UFI, UOS, UOZ, USI, UTL, UWY, VET, VFI, VNI, VSV, WIE, WEN, YUG, ZON, and mixtures or intergrowths thereof.

35. The process of any one of embodiments 29-34, wherein the zeolite has a framework type chosen from CHA and AEI.

36. The process of any one of embodiments 29-35, wherein the zeolite has a CHA framework type.

37. The process of any one of embodiments 29-36, wherein the zeolite is an aluminosilicate having a framework consisting of Si, Al, and O, wherein the molar ratio of SiO₂:Al₂O₃ in the framework is from about 2 to about 300, from about 10 to about 100, and/or from about 20 to about 50.

38. The process of any one of embodiments 33-37, wherein the acid is acetic acid.

39. The process of any one of embodiments 33-38, wherein the slurry has a concentration of the acid ranging from 0.01 wt % to 10 wt % by total weight of the slurry, 0.1 wt % to 10 wt % by total weight of the slurry, 1 wt % to 10 wt % by total weight of the slurry, and/or 0.1 wt % to 5 wt % by total weight of the slurry.

40. The process of any one of embodiments 29-39, wherein the slurry has a concentration of the transition metal ion source ranging from 0.01 wt % to 10 wt % by total weight of the slurry, 0.1 wt % to 10 wt % by total weight of the slurry, 1 wt % to 10 wt % by total weight of the slurry, and/or 0.1 wt % to 5 wt % by total weight of the slurry.

41. The process of any one of embodiments 29-40, wherein, in the slurry, a weight ratio of the ammonium form zeolite to the transition metal ion source ranges from 2:1 to 100:1, 2:1 to 50:1, 2:1 to 50:1, 5:1 to 50:1, and/or 10:1 to 30:1.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided

### EXAMPLES

Aspects of the present disclosure are more fully illustrated by the following examples, which are set forth to illustrate certain aspects of the present disclosure and are not to be construed as limiting thereof. Before describing several exemplary embodiments, it is to be understood that the disclosure is not limited to the details of construction or process steps set forth in the following description, and is capable of other embodiments and of being practiced or being carried out in various ways. Unless otherwise noted, all parts and percentages are by weight, and all weight percentages are expressed on a dry basis, meaning excluding water content, unless otherwise indicated.

### Example 1. Solution-Phase Preparation of a Copper Ion-Exchanged Zeolite Catalyst Article (Reference)

A copper ion-exchanged zeolite was prepared by a solution-phase ion exchange process from the ammonium-torn of a synthetic zeolite having the CHA framework and a silica-to-alumina ratio (SAR) of 19. Here, a SSZ-13 zeolite was crystallized using trimethyladamantyl ammonium hydroxide (TMAdaOH) as the template, and the synthesis gel had a composition with the following molar ratios: 20 SiO₂:1.0 Al₂O₃:1.42 TMAdaOH:2.6 NaOH:220 H₂O. After hydrothermal crystallization at 170° C. for 30 hours, the suspension was filtered, dried, and calcined at 540° C. for 6 hours to yield a Na⁺ form of the SSZ-13 zeolite as characterized by XRD. ICP analysis of the obtained Na-form of the SSZ-13 zeolite showed the material to have a SiO₂ to Al₂O₃ ratio (SAR) of 19. Following calcination, the Na⁺ form of the SSZ-13 zeolite was exchanged to a NH4⁺ form of the SSZ-13 zeolite with a Na content of <500 ppm as Na₂O, The ammonium-form chabazite zeolite (12 kg) was added to 66 kg of deionized water in a stirred reactor at room temperature. The reactor was heated to 60° C. in about 30 minutes. Copper acetate monohydrate (4.67 kg, 23.38 moles) was added, along with acetic acid (96 g, 1.6 moles). Mixing was continued for 60 minutes while maintaining a reaction temperature of 60° C. The reactor contents were transferred to a plate and frame filter press. The solid Cu-exchanged zeolite was washed with deionized water until the filtrate conductivity was below 200 microsiemens and then the Cu-exchanged zeolite was air-dried on the filter press. The copper loading was 5%, measured as CuO and based on the total weight of the zeolite.

The copper ion-exchanged CHA zeolite was mixed with zirconium acetate to form a, slurry, which was milled to a target particle size having a D₉₀ ranging from 5 μm to 8 μm, as measured with a Sympatec particle size analyzer. The slurry was then coated onto a cordierite substrate (cellular ceramic monolith having a cell density of 400 cpsi and a wall thickness of 6 mil), followed by drying at 130° C. and calcination at 550° C. for 1 hour.

### Example 2. Preparation of a Copper Ion-Exchanged Zeolite Catalyst Article (Inventive)

A slurry was prepared from 90.25 g of the same ammonium—form zeolite having the CHA framework of Example 1, 4.75 of copper oxide (CuO), 16.67 g of zirconium acetate aqueous solution (containing 30% zirconium oxide) and 1.8 g of acetic acid. Additional water was added to obtain a slurry having about 38% solids. The mixture was milled to a target particle size having a D₉₀ ranging from 5 μm to 8 μm, as measured with a Sympatec particle size analyzer, and the slurry was mixed for 24 hours at room temperature to allow copper ion exchange into the zeolite framework.

The slurry was coated onto a cordierite substrate (cellular ceramic monolith having a cell density of 400 cpsi and a wall thickness of 6 mil), followed by drying at 130° C. and calcination at 550° C. for 1 hour. The copper loading by weight was 5%, measured as CuO and based on the total weight of the zeolite.

### Example 3. In-Situ Ion Exchange (ISIE) Preparation of a Copper Ion-Exchanged Zeolite Catalyst Article (Reference)

A copper ion-exchanged zeolite was prepared by an in-situ ion exchange (ISIE) process from the H-form of a synthetic zeolite having the CHA framework and a silica-to-alumina ratio (SAR) of 18. The H-form CHA zeolite (90.73 g) was slurried with 4.28 g of CuO and 16.67 g of zirconium acetate aqueous solution (containing 30% zirconium oxide). The mixture was milled to target particle size having a D₉₀ ranging from 3.5 μm to 5.5 μm, as measured with a Sympatec particle size analyzer, and the slurry was mixed for 24 hours at room temperature to allow copper ion exchange into the zeolite framework. The copper loading was 4.5% measured as CuO and based on the total weight of the zeolite.

The slurry was then coated onto a cordierite substrate (cellular ceramic monolith having a cell density of 400 cpsi and a wall thickness of 6 mil), followed by drying at 130° C. and calcination at 550° C. for 1 hour.

### Example 4. Preparation of a Copper Ion-Exchanged Zeolite Catalyst Article (Inventive)

A copper ion-exchanged chabazite zeolite was prepared using the same CHA zeolite used in Example 3, but in the ammonium-form. A slurry was prepared containing the ammonium-form CHA zeolite (90.73 g), 4.28 g of CuO, 16.67 g of zirconium acetate aqueous solution (containing 30% zirconium oxide), and 1.8 g of acetic acid. The slurry was milled to target particle size having a D₉₀ ranging from 3.5 μm to 5.5 μm, as measured with a Sympatec particle size analyzer, and the slurry was mixed for 24 hours at room temperature to allow copper ion exchange into the zeolite framework. The copper loading was 4.5% measured as CuO and based on the total weight of the zeolite. Non-dispersible Boehmite alumina was added into the slurry after the 24 hour mixing period.

The final slurry was coated onto a cordierite substrate (cellular ceramic monolith having a cell density of 400 cpsi and a wall thickness of 6 mil), followed by drying at 130° C. and calcination at 550° C. for 1 hour.

### Example 5. Liquid Phase Ion Exchange (LPIE) Preparation of a Copper Ion-Exchanged Zeolite Catalyst Article (Reference)

A copper ion-exchanged zeolite was prepared from the H-form of a synthetic zeolite having the CHA framework and a silica-to-alumina ratio (SAR) of 25 by a conventional liquid phase ion-exchange (LPIE) process according to the procedure disclosed in U.S. Pat. No. 8,293,199, incorporated by reference herein in its entirety. The H-form of the chabazite zeolite (12 kg) was added to 78 kg of deionized water in a stirred reactor at room temperature. The reactor was heated to 60° C. in about 30 minutes, followed by addition of copper acetate monohydrate (2.24 kg, 11.24 moles) and acetic acid (96 g, 1.6 moles). Mixing was continued for 60 minutes while maintaining a reaction temperature of 60° C. The reactor contents were transferred to a plate and frame filter press. The Cu-exchanged chabazite zeolite was washed with deionized water until filtrate conductivity was below 200 microsiemens and then air-dried on the filter press. The copper loading was 3.7% measured as CuO and based on the total weight of the zeolite.

A slurry containing the copper ion-exchanged zeolite was mixed with zirconium acetate, and the slurry milled to target particle size having a D₉₀ ranging from 4 μm to 7 μm, as measured with a Sympatec particle size analyzer. The slurry was coated onto a cordierite substrate (cellular ceramic monolith having a cell density of 400 cpsi and a wall thickness of 6 mil), followed by drying at 130° C. and calcination at 550° C. for 1 hour.

### Example 6. Preparation of a Copper Ion-Exchanged Zeolite Catalyst Article (Inventive)

The same synthetic zeolite used in Example 5, but in ammonium-form, was slurried with CuO (in a quantity to provide a loading of 3.7% CuO by weight), 16.67 g of zirconium acetate aqueous solution (containing 30% zirconium oxide), and 1.8 g of acetic acid. The mixture was milled to target particle size and the slurry was mixed for 24 hours at room temperature to allow copper ion exchange into the zeolite framework. The slurry was coated onto a cordierite substrate (cellular ceramic monolith having a cell density of 400 cpsi and a wall thickness of 6 mil), followed by drying at 130° C. and calcination at 550° C. for 1 hour.

### Example 7. NOx Conversion Results

Samples of catalyst articles of Examples 1-6 were evaluated for NOx conversion performance. NOx conversion was tested under pseudo-steady state conditions at a temperature range of from 200° C. to 600° C. with a gas stream of 500 ppm of NO, 525 ppm of NH₃, 10% of O₂, 10% of H₂O, balanced with N₂, at a space velocity of 80,000 h⁻¹. Catalyst articles were tested after aging at 650° C. for 50 hours and at 800° C. for 16 hours in 10% steam/air.

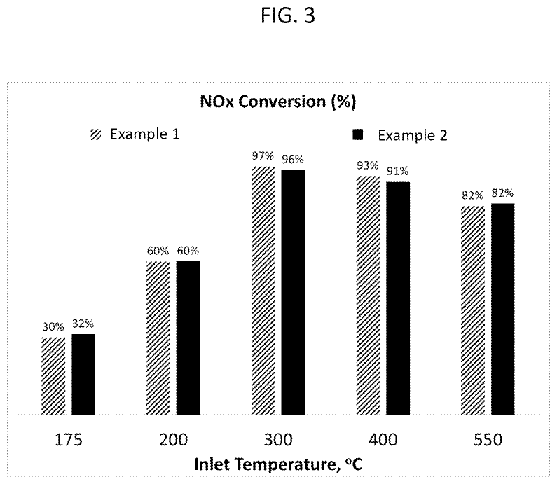

The SCR catalyst article of inventive Example 2 demonstrated similar NOx conversion to that of the reference SCR catalyst article (Example 1) for the 650° C. aged sample (FIG. 3).

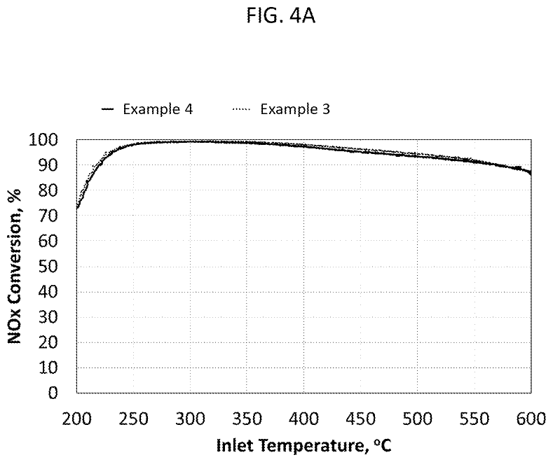

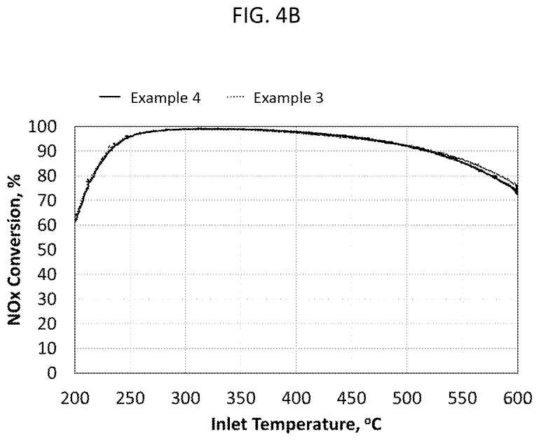

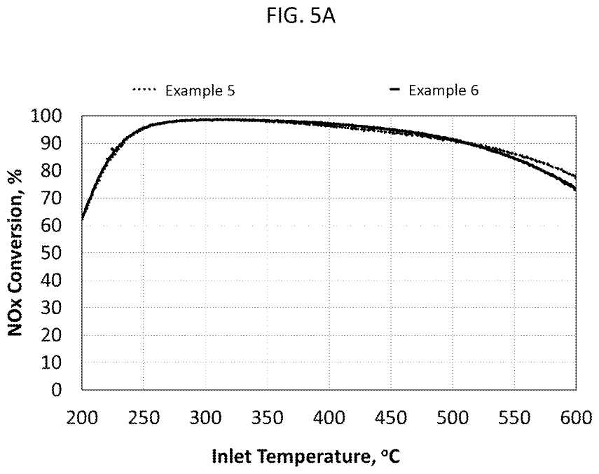

Similarly, the SCR catalyst article of inventive Example 4 demonstrated similar NOx conversion to that of the reference SCR catalyst article (Example 3) for both the 650° C. and the 800° C. aged sample (FIGS. 4A and 4B, respectively).

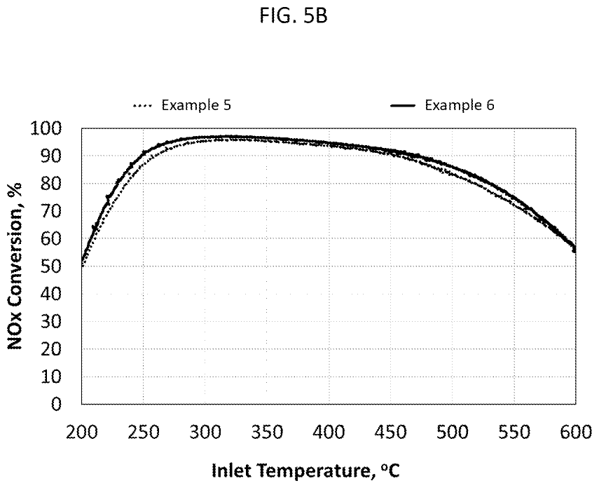

The SCR catalyst article of inventive Example 6 demonstrated similar NOx conversion to that of the reference SCR catalyst article (Example 5) for both the 650° C. and the 800° C. aged sample (FIGS. 5A and 5B, respectively).

As indicated by the NOx conversion results, in each case, the ion-exchanged zeolite catalysts prepared from an ammonium form zeolite provide performance characteristics comparable to ion-exchanged zeolite catalysts prepared from a H-form zeolite. However, the method of preparing ion-exchanged zeolite catalysts from an ammonium form zeolite did not require any tedious, labor intensive filtration or washing, nor a costly, energy-intensive, high temperature calcination to produce an intermediate H-form zeolite prior to the ion exchange. Further, the method did not result in any aqueous metal waste requiring disposal, and metal loading was precisely controlled, as the metal ion source is not required in excess (i.e., the exact amount required for a specific loading was added). Further, the method of preparing ion-exchanged zeolite catalysts from an ammonium form zeolite did not require a separate slurry formation step for coating the substrate, as the substrate is coated directly from the ion exchange slurry. Accordingly, the present disclosure provides a method which is more resource, labor, and energy efficient and more environmentally friendly than, e.g., methods of preparing ion-exchanged zeolite catalysts from a H-form zeolite.

1. A process for preparing a selective catalytic reduction catalyst comprising a transition metal ion-exchanged zeolite, wherein the process comprises
admixing an ammonium form zeolite with an aqueous mixture comprising a transition metal ion source, and, optionally, an acid, to form a slurry comprising a transition metal ion-exchanged zeolite.

2. The process of claim 1, wherein the transition metal is chosen from copper, manganese, iron, and combinations thereof.

3. The process of claim 1, wherein the transition metal ion source is a salt of the transition metal chosen from an oxide, nitrate, chloride, sulfate, acetate, hydroxide, oxalate, acetylacetonate, and carbonate.

4. The process of claim 1, wherein the transition metal ion source is copper oxide.

5. The process of claim 1, wherein the aqueous mixture comprises the acid and the acid is acetic acid.

6. The process of claim 1, wherein the zeolite has a framework type chosen from ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, CHI, CLO, CON, CZP, DAC, DDR, DFO, DFT, DOH, DON, EAB, EDI, EEI, EMT, EON, EPI, ERI, ESV, ETR, EUO, EZT, FAU, FER, FRA, GIS, GIU, GME, GON, GOO, HEU, IFR, IFY, IHW, IMF, IRN, ISV, ITE, ITG, ITH, ITW, IWR, IWS, IWV, IWW, JBW, JRY, JSR, JST, KFI, LAU, LEV, LIO, LIT, LOS, LOV, LTA, LTF, LTL, LTN, MAR, MAZ, MEI, MEL, MEP, MER, MFI, MFS, MON, MOR, MOZ, MRE, MSE, MSO, MTF, MTN, MTT, MVY, MTW, MWF, MWW, NAB, NAT, NES, NON, NPO, NPT, NSI, OBW, OFF, OKO, OSI, OSO, OWE, PAR, PAU, PCR, PHI, PON, PUN, RHO, RON, RRO, RSN, RTE, RTH, RUT, RWR, RWY, SAF, SAO, SAS, SAT, SAV, SBE, SBS, SBT, SCO, SEW, SFE, SFF, SFG, SFH, SFN, SFO, SFS, SFW, SGF, SGT, SIV, SOD, SOF, SOS, SSF, SSY, STF, STI, STO, STT, STW, SVR, SZR, TER, THO, TON, TSC, TUN, UEI, UFI, UOS, UOZ, USI, UTL, UWY, VET, VFI, VNI, VSV, WIE, WEN, YUG, ZON, and mixtures or intergrowths thereof.

7. The process of claim 1, wherein the zeolite has a framework type chosen from CHA and AEI.

8. The process of claim 1, wherein the zeolite has a CHA framework type.

9. The process of claim 1, wherein the zeolite is an aluminosilicate having a framework consisting of Si, Al, and O, wherein the molar ratio of SiO₂:Al₂O₃ in the framework is from about 2 to about 300, from about 10 to about 100, and/or from about 20 to about 50.

10. The process of claim 1, wherein the aqueous mixture further comprises a binder component.

11. The process of claim 10, wherein the binder component comprises at least one chosen from Al, Si, Ti, Zr, Ce, and mixtures thereof.

12. The process of claim 10, wherein the binder component is zirconium acetate.

13. The process of claim 1, wherein the aqueous mixture further comprises at least one additives chosen from a sugar, a dispersing agent, a surface tension reducer, a rheology modifier, and combinations thereof.

14. The process of claim 1, wherein the admixing occurs for a period of time from about 1 hour to about 48 hours, from about 12 to about 24 hours, for at least about 12 hours, or at least about 18 hours.

15. The process of claim 1, wherein the admixing is conducted at a temperature from about 10° C. to about 50° C., or from about 15° C. to about 25° C.

16. The process of claim 1, further comprising milling the aqueous mixture prior to and/or during the admixing.

17. The process of claim 1, further comprising adding a refractory metal oxide support material to the slurry following the admixing.

18. The process of claim 1, further comprising:
contacting a substrate with the slurry comprising the metal ion-exchanged zeolite to form a coating on the substrate, wherein the substrate comprises an inlet end, an outlet end, an axial length extending from the inlet end to the outlet end, and a plurality of passages defined by internal walls of the substrate extending therethrough;
drying the coated substrate;
calcining the coated substrate; and
optionally, repeating the contacting, drying, and calcining steps one or more times;
wherein the slurry is not filtered or washed prior to the contacting the substrate with the slurry.

19. The process of claim 18, wherein the drying is performed at a temperature from about 100° C. to about 150° C.

20. The process of claim 18, wherein the calcination is performed at a temperature from about 400° C. to about 600° C.

21. The process of claim 1, wherein the substrate is a flow-through substrate or a wall-flow filter.

22. The process of claim 1, wherein the transition metal ion-exchanged zeolite has an amount of transition metal ranging about 2 wt % to about 10 wt %, about 2.5 wt % to about 5.5 wt %, or about 3 wt % to about 5 wt %, based on a weight of the transition metal ion-exchanged zeolite and calculated as a transition metal oxide.
